(19) United States
(12) Patent Application Publication
(10) Pub. No.: US 2025/0033736 A1
(43) Pub. Date: Jan. 30, 2025

(54) CHAINLESS HYBRID ELECTRIC BICYCLE

(71) Applicants: Fu CHAI, Taichung (TW); Fang-Jyun CHAI, Taichung (TW)

(72) Inventors: Fu CHAI, Taichung (TW); Fang-Jyun CHAI, Taichung (TW)

(21) Appl. No.: 18/779,931

(22) Filed: Jul. 22, 2024

(30) Foreign Application Priority Data
Jul. 25, 2023 (TW) 112213941

(51) Int. Cl. B62M 6/45; B60L 50/15

(52) U.S. Cl. CPC B62M 6/45; B60L 50/15; B60L 2200/12

(57) ABSTRACT

A chainless hybrid electric bicycle includes a bicycle body. A generator, a battery pack, a driving motor and a manual switch are mounted on the bicycle body. The generator is coaxially mounted with the pedal transmission unit, so that the generator generates an electric power when the rider works the pedals. The battery pack is electrically connected to the generator for storing the electric power generated by the generator. The driving motor drives the wheels of the bicycle body to run. The rider selects the electric power from the generator or the battery pack through the manual switch to drive the driving motor to run, which in turn drives the bicycle body to move forward. The chainless hybrid electric bicycle has the advantage of a hybrid power drive system, without using traditional mechanical transmission components such as chains and chainrings.

### FIELD OF THE INVENTION

The present invention relates to a bicycle, and more particularly, to a chainless hybrid electric bicycle.

### BACKGROUND OF THE INVENTION

A bicycle is a convenient means of transportation. When the rider works the pedals of a crank assembly, the chainring coaxial with the cranks is rotated. The wheels at the other end of the chain are rotated by the transmission of the chain, which in turn drives the bicycle to move forward. Bicycles not only have the function of transportation but also have the effect of fitness. They are an excellent means of transportation for leisure and sports. Because bicycles do not require additional fuel, they can save energy consumption and are environmentally friendly. Besides, bicycles are slower and safer to use. The demand for bicycles has been on the rise in recent years. Bicycles are one of the most popular means of transportation or fitness equipment in recent years. With the popularity of bicycles, more and more people are using bicycles as a means of transportation. Therefore, in order to allow people who use bicycles as a means of transportation for a medium or long distance to save energy during the ride, electric bicycles are developed on the market. Existing bicycles are equipped with electric motors and batteries. The battery provides the electric power required for driving the electric motor, so that the electric motor drives the bicycle to move forward, thereby reducing fatigue. In order to prevent the battery from running out of power while the bicycle is moving, the bicycle is equipped with a generator. The generator generates electricity while the bicycle is moving and charge the battery at the same time to increase the battery's power.

However, the above-mentioned electric bicycle based on the mechanical transmission structure of the existing bicycle using the chainring to drive the chain is equipped with an electric motor, a battery, a generator, etc., so as to achieve a power-assisted function. There is a risk of the chain falling off or of the rider's skirt and pants being stained or entangled by chainrings, chains and other components. Besides, there is a need for regular maintenance of chainrings, chains and other components.

Accordingly, the inventor of the present invention has devoted himself based on his many years of practical experiences to solve these problems.

### SUMMARY OF THE INVENTION

The primary object of the present invention is to provide a chainless hybrid electric bicycle, which has the advantage of a hybrid power drive system, without using traditional mechanical transmission components such as chains and chainrings.

In order to achieve the foregoing object, the chainless hybrid electric bicycle provided by the present invention comprises a bicycle body, a generator, a battery pack, a driving motor, and a manual switch. At least two wheels are pivotally connected to the bicycle body for moving the bicycle body. A handlebar is disposed at a front of the bicycle body. A pedal transmission unit is pivotally connected to the bicycle body. A pair of pedals are disposed on two sides of the pedal transmission unit for a rider to tread the pedals. The generator is mounted on the bicycle body. The generator is coaxially mounted with the pedal transmission unit. The generator generates an electric power when the rider works the pedals. The battery pack is mounted on the bicycle body. The battery pack is electrically connected to the generator for storing the electric power generated by the generator. The driving motor is mounted on the bicycle body. The driving motor is electrically connected to the generator and the battery pack. The driving motor is rotated by the electric power from the generator or the battery pack to drive the wheels to run. The manual switch is mounted on the handlebar and located between the generator, the battery pack and the driving motor. The rider selects the electric power from the generator or the battery pack through the manual switch to drive the driving motor to run.

### BRIEF DESCRIPTION OF THE DRAWINGS

FIG. 1 is a schematic view of a preferred embodiment of the present invention;

FIG. 2 is a block diagram of the circuit of the preferred embodiment of the present invention; and

FIG. 3 is a flow chart of the operation of the preferred embodiment of the present invention.

### DETAILED DESCRIPTION OF THE PREFERRED EMBODIMENTS

Embodiments of the present invention will now be described, by way of example only, with reference to the accompanying drawings.

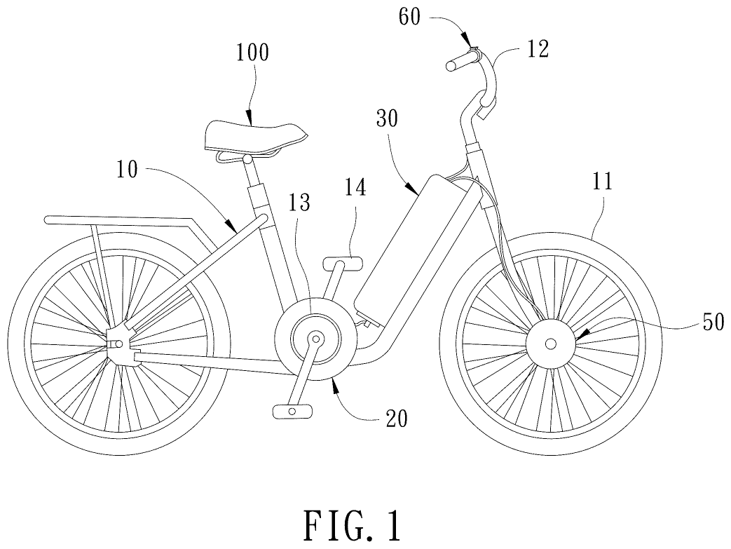

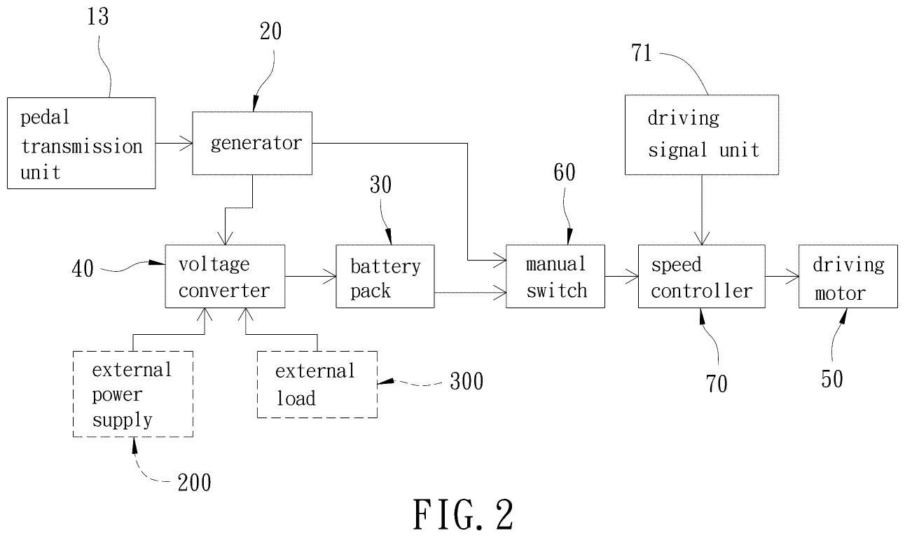

FIG. 1 is a schematic view of a preferred embodiment of the present invention. FIG. 2 is a block diagram of the circuit of the preferred embodiment of the present invention. The present invention discloses a chainless hybrid electric bicycle, comprising a bicycle body 10, a generator 20, a battery pack 30, a voltage converter 40, a driving motor 50, a manual switch 60, and a speed controller 70.

At least two wheels 11 are pivotally connected to the bicycle body 10 for moving the bicycle body 10. A handlebar 12 is disposed at the front of the bicycle body 10. A pedal transmission unit 13 is pivotally connected to the bicycle body 10. In this embodiment, the pedal transmission unit 13 is a gear crank assembly. A pair of pedals 14 are provided on both sides of the pedal transmission unit 13 for a rider to tread the pedals 14.

The generator 20 is mounted on the bicycle body 10. In this embodiment, the generator 20 is a pedal planetary generator. The generator 20 is coaxially mounted with the pedal transmission unit 13. The generator 20 generates electric power when the rider works the pedals 14.

The battery pack 30 is mounted on the bicycle body 10. The battery pack 30 is electrically connected to the generator 20 for storing the electric power generated by the generator 20.

The voltage converter 40 is electrically connected between the generator 20 and the battery pack 30. The voltage converter 40 may be connected to an external power supply 200 or an external load 300. The voltage converter 40 converts the voltage generated by the generator 20 to an appropriate voltage for the external power supply 200 to supply electric power to the battery pack 30 or to the external load 300 as a power source. The voltage converter 40 has an automatic switching function for outputting the electric power to the external load 300. When the external load 300 is not connected to the voltage converter 40, the electric power generated by the generator is used to recharge the battery pack; when the external load 300 is connected to the voltage converter 40, the electric power generated by the generator is output to the external load 300.

The driving motor 50 is mounted on the bicycle body 10. In this embodiment, the driving motor 50 is mounted on the hub of the wheel 11 in front of the bicycle body 10. The driving motor 50 is electrically connected to the generator 20 and the battery pack 30, so that the driving motor 50 can be rotated by the electric power of the generator 20 or the battery pack 30, thereby driving the wheels 11 to run for the bicycle body 10 to move forward.

In this embodiment, the manual switch 60 is mounted on the handlebar 12 for easy operation by the rider. The manual switch 60 is electrically connected between the generator 20, the battery pack 30 and the driving motor 50. The rider can select the electric power from the generator 20 or the battery pack 30 through the manual switch 60 to drive the driving motor 50 to run.

The speed controller 70 is electrically connected between the manual switch 60 and the driving motor 50, and the speed controller 70 is electrically connected to a driving signal unit 71. The driving signal unit 71 generates a driving signal by turning a handle or pedaling. In this embodiment, the driving signal unit 71 is a handle-type throttle, and the driving signal is generated by turning the handle. The rider turns the handle to output a signal to the speed controller 70, thereby controlling the rotational speed of the driving motor 50.

In order to further understand the structural features, technical means and expected effects of the present invention, the operation of the present invention is described below.

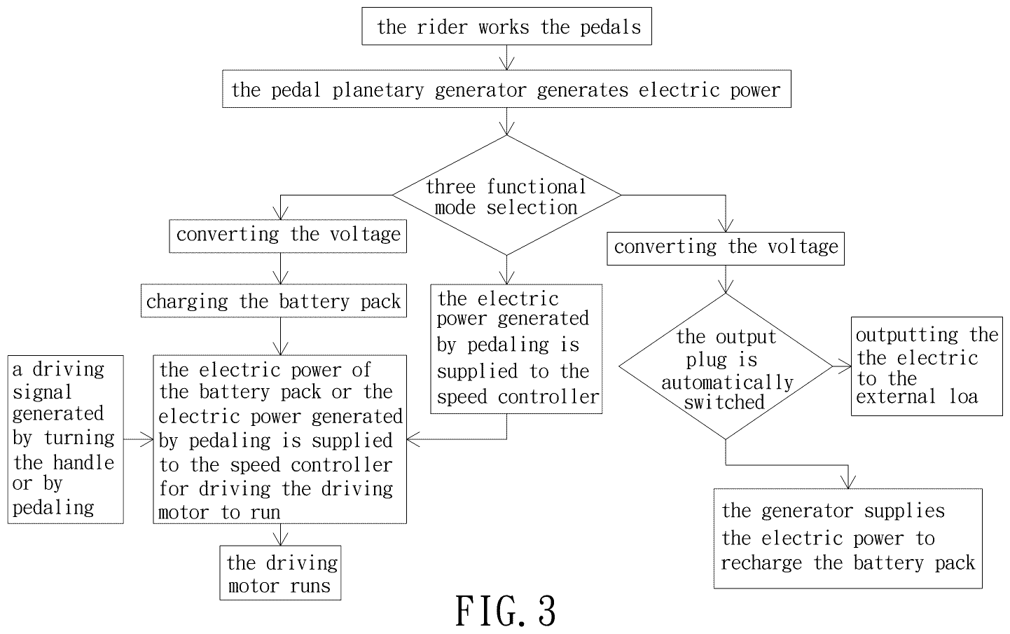

FIG. 3 is a flow chart of the operation of the preferred embodiment of the present invention. The present invention has three functional modes for the rider to choose.

As to the first functional mode, the rider works the pedals 14 of the pedal transmission unit 13 for the pedal planetary generator 20 to generate electric power. After the electric power is converted to an appropriate voltage by the voltage converter 40, the battery pack 30 is charged. Then, the battery pack 30 transmits the electric power to the speed controller 70. The speed controller 70 controls the operation of the driving motor 50 according to the signal from the driving signal unit 71. Then, the driving motor 50 drives the wheels 11 to run, so that the electric bicycle 100 moves forward by means of rotation of the wheels 11.

As to the second functional mode, the rider works the pedals 14 of the pedal transmission unit 13 for the pedal planetary generator 20 to generate electric power. The electric power is directly transmitted to the speed controller 70. The speed controller 70 controls the operation of the driving motor 50 according to the signal from the driving signal unit 71. Then, the driving motor 50 drives the wheels 11 to run, so that the electric bicycle 100 moves forward by means of rotation of the wheels 11.

As to the third functional mode, the rider works the pedals 14 of the pedal transmission unit 13 for the pedal planetary generator 20 to generate electric power. The electric power is converted to an appropriate voltage by the voltage converter 40 to be output. Because the voltage converter 40 has the automatic switching function, when the external load 300 is not connected to the voltage converter 40, the electric power from the generator is used to recharge the battery pack; when the external load 300 is connected to the output plug of the voltage converter 40, the electric power from the generator is output to the external load 300.

It is worth mentioning that the chainless hybrid electric bicycle may use the electric power stored in the battery pack 30 to drive the driving motor 50 to run, instead of pedaling the pedal transmission unit 13 for the generator 20 to generate electric power, which in turn to move the electric bicycle 100 forward, forming a pure electric bicycle.

The advantages and the expected effects of the present invention are summarized and explained as follows:
1. The generator of the present invention is a pedal planetary generator, which is coaxially mounted with the cranks of the pedals. When the rider works the pedals, the generator is directly driven to generate electric power, thereby generating the electric power required by the driving motor, without using traditional mechanical structures such as chainrings and chains. There is no risk of the chain falling off or of the skirt and pants being stained or entangled by chainrings, chains and other components. Besides, there is no need for regular maintenance of chainrings, chains and other components. By reducing the number of components, the manufacturing cost of the bicycle can be reduced.
2. In the present invention, the pedal transmission unit is in cooperation with an electric system that includes the generator, the battery pack, and the driving motor. Thus, the power source of the bicycle may be the electric power generated by the generator by working the pedals or the electric power provided by the battery pack, thereby forming a hybrid power system. Therefore, the rider can choose an appropriate power supply mode according to the purpose or distance of the ride. The bicycle not only achieves the function of transportation but also achieves the effect of sports, leisure and fitness.
3. When the output plug of the voltage converter is connected to the external load, the present invention has an automatic switching function for outputting the electric power to the external load. Therefore, the present invention may be used as a pedal generator as a temporary or emergency power supply apparatus. For example, when the utility power goes out or when camping in the wild, as long as the electric bicycle is positioned in place and the user works the pedals continuously, such that the generator generates electric power to the external load, such as lighting equipment.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A chainless hybrid electric bicycle, comprising:
a bicycle body, at least two wheels being pivotally connected to the bicycle body for moving the bicycle body, a handlebar being disposed at a front of the bicycle body, a pedal transmission unit being pivotally connected to the bicycle body, a pair of pedals being disposed on two sides of the pedal transmission unit for a rider to tread the pedals;
a generator, mounted on the bicycle body, the generator being coaxially mounted with the pedal transmission unit, the generator generating an electric power when the rider works the pedals;
a battery pack, mounted on the bicycle body, the battery pack being electrically connected to the generator for storing the electric power generated by the generator.
a driving motor, mounted on the bicycle body, the driving motor being electrically connected to the generator and the battery pack, the driving motor being rotated by the electric power from the generator or the battery pack to drive the wheels to run;
a manual switch, mounted on the handlebar and located between the generator, the battery pack and the driving motor, wherein the rider selects the electric power from the generator or the battery pack through the manual switch to drive the driving motor to run.

2. The chainless hybrid electric bicycle as claimed in claim 1, wherein a voltage converter is provided between the generator and the battery pack, and the voltage converter is selectively connected to an external power supply or an external load.

3. The chainless hybrid electric bicycle as claimed in claim 2, wherein the voltage converter has an automatic switching function for outputting the electric power to the external load, when the external load is not connected to the voltage converter, the electric power from the generator is used to recharge the battery pack; when the external load is connected to the voltage converter, the electric power from the generator is output to the external load.

4. The chainless hybrid electric bicycle as claimed in claim 1, wherein a speed controller is provided between the manual switch and the driving motor.

5. The chainless hybrid electric bicycle as claimed in claim 4, wherein a driving signal unit is provided on the handlebar, the driving signal unit is electrically connected to the speed controller, and the rider operates the driving signal unit to output a signal to the speed controller, thereby controlling a rotational speed of the driving motor.

6. The chainless hybrid electric bicycle as claimed in claim 5, wherein the driving signal unit is a handle-type throttle.

7. The chainless hybrid electric bicycle as claimed in claim 1, wherein the pedal transmission unit is a gear crank assembly.

8. The chainless hybrid electric bicycle as claimed in claim 1, wherein the generator is a pedal planetary generator.

9. The chainless hybrid electric bicycle as claimed in claim 1, wherein the driving motor is mounted on a hub of the wheel.
